(19) United States
(12) Patent Application Publication
(10) Pub. No.: US 2005/0268240 A1
(43) Pub. Date: Dec. 1, 2005

(54) Softkey configuration

(75) Inventor: Teemu Kankaanpaa, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/129,655

(22) Filed: May 13, 2005

(30) Foreign Application Priority Data
May 14, 2004 (WO) PCT/FI04/50066

(51) Int. Cl. G06F 3/00; H04B 1/38

(52) U.S. Cl. 715/747; 715/745; 715/827; 455/566

(57) ABSTRACT

A method for controlling functions of an apparatus that comprises a user interface with at least one control means for controlling multiple functions of the apparatus. The apparatus has a plurality of user-adjustable operating profiles, and that in the method at least one of the functions of the control means is defined operating profile-specifically. The invention also relates to a device as well as to a system and a computer program product.

### CROSS-REFERENCE TO RELATED APPLICATIONS

This application claims priority under 35 USC §119 to International Patent Application No. PCT/FI2004/050066 filed on 14 May 2004.

The invention relates to a method for controlling functions of an apparatus. The invention also relates to a device, as well as to a system and a computer program product.

### BACKGROUND OF THE INVENTION

Typically a mobile phone is provided with a user interface including one or more multi-function keys, later softkeys, with multiple functionality for accessing different features of the phone. These features can, for example, include user settings, handling messages, setting call options, security options, etc.

Some examples of a user interface including a softkey are disclosed in U.S. Pat. No. 6,381,468 and U.S. Pat. No. 6,453,179, which describe a user interface where the present functionality of the softkey is displayed on the display of a mobile phone.

One weakness in currently known solutions is that the functionality of the softkeys in the idle mode is the same regardless of the context in which the user is using the phone. Still, a user might have a need for very different functions of the softkeys in different situations. For example, a softkey set to “camera” mode is of no use when the user is driving a car and the phone is attached to a car kit.

Therefore, there exists a need in mobile technology for a system and a method that provides context dependent softkey configuration without the above mentioned limitations. The system and method should be easy to use.

### SUMMARY OF THE INVENTION

It is an aim of the invention to introduce solutions to how the control means (as the softkey) may have different functionality in different situations, depending on the context in which the user is using the terminal (as a mobile phone, a communicator, a communication device, a computer, a PDA, etc.).

To attain this purpose, the invention relates to a method for controlling at least one function of an apparatus that comprises a user interface with at least one control means for controlling multiple functions of the apparatus, wherein the apparatus has a plurality of user-adjustable operating profiles, and that in said method at least one of the functions of said control means is defined operating profile-specifically. The device comprises a user interface and a controller unit connected to the user interface, said user interface comprising at least one control means for controlling multiple functions of the device, wherein the device has a plurality of user-adjustable operating profiles, and that said device comprises means for defining at least one of said control means operating profile-specifically. The system with a computer comprises a user interface, said user interface comprising at least one control means for controlling multiple functions of the system, wherein the computer has a plurality of user-adjustable operating profiles and that said system comprises means for defining at least one of said control means operating profile-specifically. In addition, the invention relates to a computer program product for controlling at least one function of an apparatus, that comprises a user interface with at least one control means for controlling multiple functions of the apparatus, wherein there is a plurality of user-adjustable operating profiles, and in said program at least one of the functions of said control means is defined operating profile-specifically.

The basic idea of the invention is to use profile information to control the functionality of the control means (for example a softkey). It is known that the user can change various settings of the phone so that they will better suit the current situation and environment. This is accomplished by means of profiles. One example of profiles is disclosed in U.S. Pat. No. 5,479,476. In this known solution the user cannot change the functionality of the softkeys in different profiles (but a certain profile can be configured to be automatically activated when an enhancement is attached). Common profiles are for example: indoors, outdoors, conference/theatre, car and personal. In known solutions the user can change for example: sound volume, ringing tone, key tones, warning tones, lights and call transfer.

In the present invention a mobile terminal comprises a user interface and a controller unit connected to the user interface. Said user interface comprises means for displaying information and at least one control means for controlling multiple functionalities of the terminal, and the function of the control means is displayed on the display. The terminal also has a plurality of user-adjustable operating characteristics and means for adjusting said operating characteristics. There are means for defining a plurality of groups of said operating characteristics, and each said group includes a plurality of said user-adjustable operating characteristics, where at least the idle mode function of the control means is one of said user-adjustable operating characteristics. There are also means for selecting one of said defined plurality of groups to control the operation of said control means and terminal at least partially in accordance with the user-adjustable characteristics of said groups.

In one embodiment of the invention the user can configure the softkeys to have different functionality in different profiles. This will allow the user to configure the softkeys to have a functionality that is most useful in the current situation. (As stated above, the change can be triggered by attaching an enhancement.)

In another embodiment of the invention a user interface has one or more softkeys that have different functionality depending on the status of the phone. The user can configure the functionality of the softkeys in the idle mode. The functionality in the idle mode can be for example an application that is frequently needed.

In another embodiment the softkey functionalities are included in the settings, which the user can change in the profiles.

The user will be able to change the functionality of the softkeys so that they will be more useful in different situations. For example, instead of the “camera” function, a user might prefer the “recorder” function when driving a car and the car kit is attached.

Different embodiments according to this invention can be used and implemented in many environments and in many ways. Examples of these apparatuses include mobile phones, communication devices, PDAs, computers as well as devices containing functions of one or several aforementioned apparatuses. In some systems some of the described functions can be executed in different parts of the system. For example a display, control means and a control unit can be situated in different units, but still carry out this context dependent control of the control means.

### BRIEF DESCRIPTION OF THE DRAWINGS

In the following, the invention will be described in more detail with reference to the appended principle drawings, in which

FIG. 1 shows an embodiment of a mobile phone having a user interface according to the invention,

FIG. 2 is a flow diagram illustrating the decision process in the controller unit in the phone according to the invention,

FIG. 3 is another flow diagram illustrating the decision process in the controller unit in the phone according to the invention,

FIG. 4 shows the relationship between operating characteristics and defined groups, and

FIGS. 5 to 12 show some views of the displays of the user interfaces according to the invention.

In the figures the examples are shown in a simplified manner, and they are not, for example, drawn to scale when compared with the actual embodiment. Furthermore, the figures primarily show details that help to understand the invention. Other details are left out of the figures for the sake of clarity.

### DETAILED DESCRIPTION OF THE INVENTION

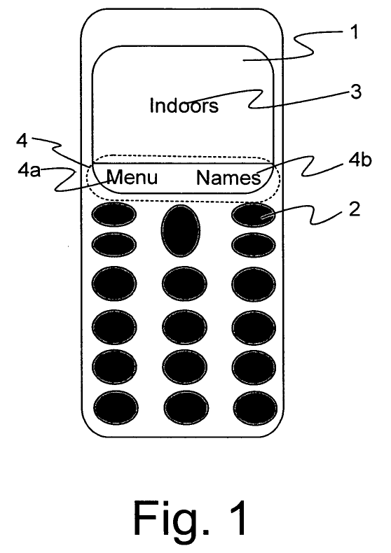

FIG. 1 shows an embodiment of a mobile phone having a user interface according to the invention. The mobile phone comprises a user interface and the user interface comprises a display 1 for displaying information and at least one control means 2 for controlling multiple functions of the terminal, and the function of the control means is displayed on the display. In this embodiment, the control means 2 are softkeys, but it is also possible to use other types of control means (for example touch screen). The name of the profile 3—“Indoors”—and the functions of the softkeys 4—“Menu” 4a and “Names” 4b—are shown on the display.

The mobile phone has a plurality of user-adjustable operating characteristics and means for adjusting said operating characteristics. It is possible to define a plurality of groups (profiles) of said operating characteristics and each said profile includes a plurality of said user-adjustable operating characteristics, where at least the function of the softkeys 2 in the idle mode is one of said user-adjustable operating characteristics. One of said defined profiles can be selected to control an operation of said softkeys 2 and phone at least partially in accordance with the user-adjustable characteristics of said profiles. In one embodiment the user selects the profile and in another embodiment a certain profile can be configured to be automatically activated when an enhancement is attached.

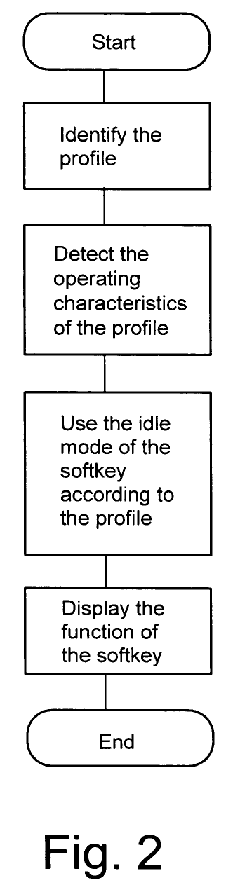

FIG. 2 shows a flow diagram illustrating the process in the controller unit in the terminal according to the invention. First the controller unit receives and identifies information of the profile in use. Then the controller unit retrieves and detects the operating characteristics of the profile, where at least the function of the softkey(s) 2 in the idle mode is one of said operating characteristics. This idle mode function of the softkey(s) 2 is set in use, and the function of the softkey(s) 4 is displayed on the display 1.

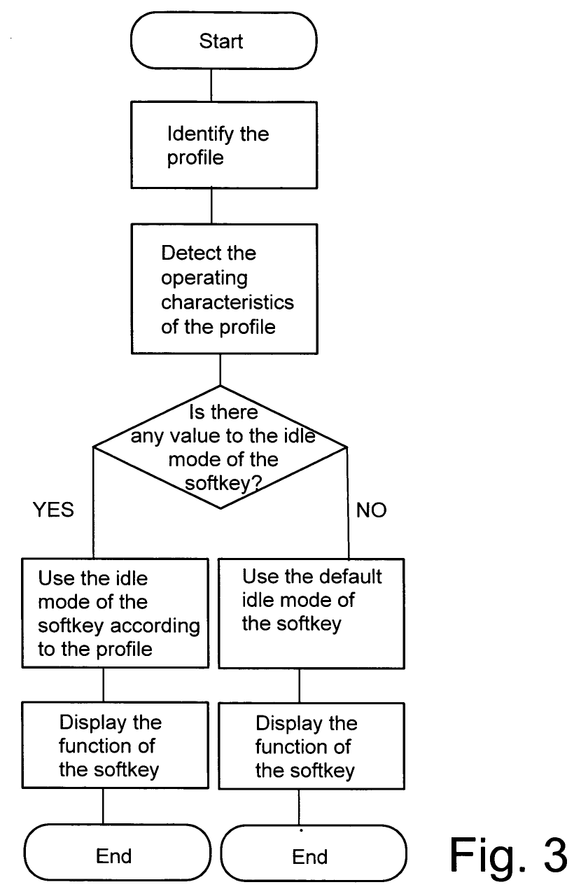

FIG. 3 shows another flow diagram. In this embodiment the controller unit receives and identifies information of the profile in use. Then the controller unit retrieves the operating characteristics of the profile and detects the operating characteristics. If there is a value for the idle mode function of the softkey(s) 2 in said operating characteristics, this idle mode function of the softkey(s) is set in use, and the function of the softkey(s) 4 is displayed on the display 1. If a value is not determined for the idle mode function of the softkey(s) 2, it is used in one embodiment as a default value and thus as a default idle mode function of the softkey(s).

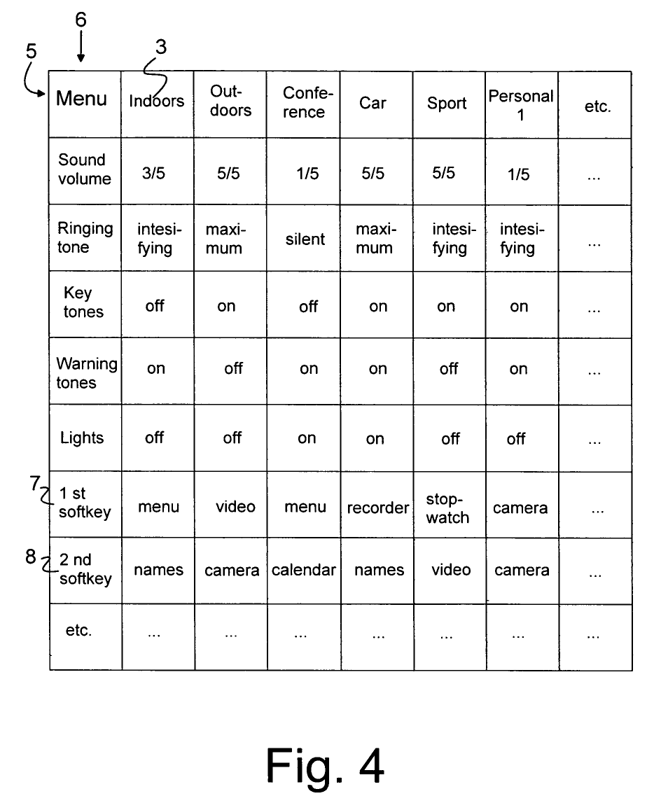

FIG. 4 shows the relationship between operating characteristics and defined groups in one embodiment of the invention. The upper row 5 in the figure represents various situations (profile names 3) which may be selected. These profile names 3 are “indoors”, “outdoors”, “conference”, “car” and “sport”. The characteristics set by the selection of the ambient condition are presented in the column 6 on the left-hand side of the figure. As shown in the figure, these settings include settings for output volume, ringing volume, key tones, warning tones, lights, first softkey 7 and second softkey 8.

When the “indoors” profile 3 is selected, the output sound volume is set to three fifths of its maximum value and the ringing tone is set so that it starts at a low volume that is steadily amplified while the call remains unanswered. The key tones option is set to the “off” position, so that tones are not generated while keys are depressed. The warning tones option is set to the “on” position, so that, where appropriate, audible warning tones are generated. The lights option is set to the “off” position, so that the internal light source of the phone is not activated. The first softkey 7 option is set to “menu” position, so that said first softkey controls the menu function in idle mode. The second softkey 8 option is set to “names” position, so that said second softkey controls names function in the idle mode. These functions are only examples and the functionality in the idle mode can be for example an application that is frequently needed.

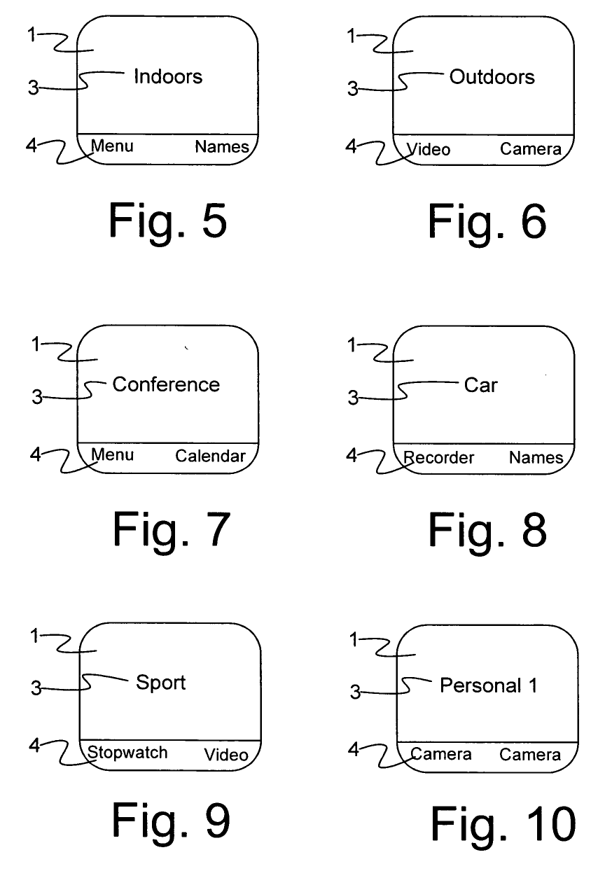

When the terminal is in the idle mode texts 4 “menu” and “names” are shown on the display 1, said texts relating to the first and the second softkey 2. FIG. 5 shows one example of such a view of the display 1.

When the “outdoors” profile 3 is selected, the first softkey 7 option is set to “video” position, so that said first softkey controls the video function in the idle mode (in this example). The second softkey option 8 is set to “camera” position, so that said second softkey controls the camera function in the idle mode. Thus, when the terminal is in the idle mode the texts 4 “video” and “camera” are shown on the display 1, as can be seen in FIG. 6. (Naturally, the other operating characteristics of the profile 3 are activated at the same time.)

When the “conference” profile 3 is selected, the first softkey option 7 is set to “menu” position and the second softkey option 8 is set to “calendar” position. Thus when the terminal is in the idle mode the texts 4 “menu” and “calendar” are shown on the display 1 as can be seen in FIG. 7.

When the “car” profile 3 is selected, the first softkey option 7 is set to “recorder” position and the second softkey option 8 is set to “names” position. FIG. 8 shows the view on the display 1 in idle mode when the car profile 3 is selected.

When the “sport” profile 3 is selected, the first softkey 7 option is set to “stopwatch” position and the second softkey option 8 is set to “video” position. Thus, when the terminal is in the idle mode texts 4 “stopwatch” and “video” are shown on the display 1 as can be seen in FIG. 9.

In many situations it is useful that the different softkeys 2 have different functions. It is, however, possible that the user sometimes wants to set two or more softkeys 2 to control the same function. When the “personal 1” profile 3 is selected, the first softkey option 7 is set to “camera” position and the second softkey option 8 is set to “camera” position as well. Thus, when the terminal is in the idle mode, the text 4 “camera” is shown twice on the display 1 as can be seen in FIG. 10. In this embodiment the softkey 2 type control means are used, but it is also possible to use voice controlled control means, and thus it is in some cases more reliable and/or user friendly if there is only one selectable function.

Profile dependent softkeys can also be implemented in various other ways, since the softkey 2 is connected to the function in accordance with the settings. In one embodiment it is possible to freely determine the name of the softkey 2 and connect said softkey to the desired function. This enables for example the use of softkeys 2 with the same name in different profiles, said softkeys, however, possibly activating different functions. For example in one embodiment, the value “text message” is established for one softkey 2 both in the “indoors” profile and in the “car” profile. When the “text message” softkey 2 is activated in the “indoors” profile, the typing of the message can be started by means of the keyboard. In the “car” profile the activation of the softkey 2, in turn, starts a speech recognition application so that it is possible to dictate the text message. Thus, the user is aware of the fact that the activation of the “text message” softkey 2 starts an application enabling the creating of a text message, and the way in which the content of the message is input depends on the profile in question.

In this embodiment, the operating characteristics are predetermined during the manufacture. In one embodiment the user defines all operating characteristics and in another embodiment a service provider determines the characteristics (which the user can in one embodiment load from the server of the service provider).

The user can adjust the operating characteristics in many ways. In one embodiment the user picks up the value from the list. This is very useful in many applications, but when there are many alternative operating characteristics, the list could be very long. In another embodiment the user can define the value for the softkey 2 by means of teaching. When the user starts defining the operating characteristics of the profile 3, he or she first selects one operating characteristics (for example the 1 st softkey 7). Then the user defines the value (which in this case is a function) of the characteristics thus starting the teaching mode. In one embodiment of the teaching mode the user uses the normal menu structure to find and to determine the function of the softkey 2. Thus when the user finds the function he/she is looking for he/she determines the function and stops the teaching mode.

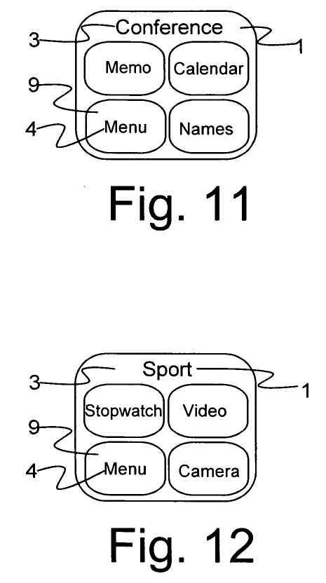

In the above-presented embodiments of the invention softkey type control means 2 were used. In other embodiments, the control means 2 can be some of another type as well. In one embodiment the user interface is of a touch screen type and thereby the control means 2 are arranged on the touch screen. FIGS. 11 and 12 show two examples of the touch screen type user interface according to this invention. In these examples there are four control means 2 on the screen 1 and all of them are adjustable, depending on profile 3 in use.

When the “conference” profile 3 is selected, the first control means option 7 is set to “memo” position, the second control means option 8 is set to “calendar” position, the third control means option is set to “menu” position and the fourth control means option is set to “names” position. Thus, when the terminal is in the idle mode the texts 4 “memo”, “calendar” “menu” and “names” are shown on the display, as can be seen in FIG. 11. These texts 4 are shown in the selection elements 9 of the touch screen 1 and pushing of one of these elements 9 starts said function.

When the “sport” profile 3 is selected, the first control means option 7 is set to “stopwatch” position, the second control means option 8 is set to “video” position, the third control means option is set to “menu” position and the fourth control means option is set to “camera” position. Thus when the terminal is in the idle mode the texts 4 “stopwatch”, “video” “menu” and “camera” are shown on the display, as can be seen in FIG. 12.

In the different embodiments of the invention presented above the idle mode has been used as an example of the mode of the apparatus. It is also possible to produce such embodiments of the invention in accordance with the spirit of the invention where the mode of the apparatus is different from said idle mode. Similarly, the softkey function can be indicated in other ways as well, for example by means of an audio signal.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention can be freely varied within the scope of the inventive features presented in the claims hereinbelow.

1. A method for controlling at least one function of an apparatus that comprises a user interface with at least one control means for controlling multiple functions of the apparatus,
wherein the apparatus has a plurality of user-adjustable operating profiles, and that in said method at least one of the functions of said control means is defined operating profile-specifically.

2. The method according to claim 1, wherein the function of said control means in a profile is determined by a user.

3. The method according to claim 1, wherein the function of said control means in a profile is determined by a service provider.

4. The method according to claim 1, wherein the function of said control means in a profile is determined during the manufacture of the apparatus.

5. A device comprising a user interface and a controller unit connected to the user interface, said user interface comprising at least one control means for controlling multiple functions of the device,
wherein the device has a plurality of user-adjustable operating profiles, and that said device comprises means for defining at least one of said control means operating profile-specifically.

6. The device according to claim 5, wherein the device also comprises means for presenting the function of the control.

7. The device according to claim 5, wherein at least one control means is a softkey.

8. The device according to claim 5, wherein at least one control means is arranged on the touch screen.

9. The device according to claim 5, wherein at least one control means is voice controlled.

10. The device according to claim 5, wherein the device is at least one of the following: a mobile terminal, a mobile phone, a communication device, a PDA.

11. A system with a computer comprising a user interface, said user interface comprising at least one control means for controlling multiple functions of the system,
wherein the computer has a plurality of user-adjustable operating profiles and that said system comprises means for defining at least one of said control means operating profile-specifically.

12. The system according to claim 11, wherein the system also comprises means for presenting the function of the control means.

13. The system according to claim 11, wherein at least one control means is a softkey.

14. The system according to claim 11, wherein at least one control means is arranged on the touch screen.

15. The system according to claim 11, wherein at least one control means is voice controlled.

16. A computer program product for controlling at least one function of an apparatus, wherein the apparatus comprises a user interface with at least one control means for controlling multiple functions of the apparatus,
wherein there is a plurality of user-adjustable operating profiles, and that the computer program product has code stored on a readable medium for execution on a processor so that at least one of the functions of said control means is defined operating profile-specifically.
